(19) United States
(12) Patent Application Publication
(10) Pub. No.: US 2005/0144083 A1
(43) Pub. Date: Jun. 30, 2005

(54) Method and system for locating, selecting, purchasing and delivering small unit research information

(76) Inventor: Paul Francis Christ, Blue Bell, PA (US)

Correspondence Address: PAUL F. CHRIST, 615 JUNIPER DRIVE, BLUE BELL, PA, 19422, US

(21) Appl. No.: 10/749,952

(22) Filed: Dec. 31, 2003

(51) Int. Cl. G06F 17/60

(52) U.S. Cl. 705/26

(57) ABSTRACT

A method and system for allowing a user to locate, select, purchase and receive delivery of small unit research information involving using an interface device, connected to an electronic and/or communications channel(s), to access a research item information system. To enable purchase of small unit research information the invention provides access to elements to allow purchase transactions using micropayment transactions. Micropayments for small unit items provide a mechanism for keeping the cost of transactions low and thus allowing for electronic purchase in small denominations. Upon purchase the system manages the delivery of purchased small unit research information from its electronic and/or communications channel(s) location.

### BACKGROUND—FIELD OF INVENTION

This invention generally relates to the field of market research, and more particularly, to a method and system to facilitate the acquisition of small unit research information.

### BACKGROUND—DESCRIPTION OF PRIOR ART

There are many situations that require one party to acquire research information from another party. In this context, research information relates to material used to educate, understand, gain knowledge, comprehend, inform others or other criteria for which research information may be used. The most common example of this is when someone is writing or presenting material on a subject and to assist with their efforts they need to acquire information. For instance, a business professional may be preparing a business plan that requires information on the industry they operate in such as competitor information or market statistics. In addition to the business environment, there are many other situations in which research information is needed. Some examples may include: a medical doctor who is researching information on the number of occurrences of a particular disease in a certain geographic area, a magazine report who seeks statistics on the number of lawsuits filed against a certain party, a market research firm that is creating a market report that needs additional supporting evidence for the information they have produced, and a trade exporter who would like to know the value of a certain product category in another country. These are just a few of many ways in which research information may be used.

Until the advent of computer technology, most research information was obtained through either written methods, such as obtaining a research document, or through verbal means, such as having someone tell another person. For example, a university student who is writing a research paper for a class would visit the university library, possibly seek assistance from a reference librarian who would direct the student to one or more reference materials that may contain the information the student seeks. This process is often a difficult chore since it could be very time consuming and there is the chance the library does not own or have access to the required information. However, with improvements in computer technology and, in particular, the advent of computer networks such as the Internet, acquiring research information can now be carried out in electronic form. For example, the student can now locate the information over the Internet without the need to visit the library or, for students that visit the library, the library may now offer access via the Internet to many more materials which they previously could not afford to own.

Research information delivered electronically has generally followed a process in which the research item may be obtained free of charge or requires those seeking to obtain the information to pay a fee to acquire the information. For those situations in which material is obtained for a fee the research information supplier often requires the acquirer to purchase an entire report that may contain the information that is sought. For example, a marketing person who is preparing a marketing plan for their company and seeks information on the forecasted sales for the market over a three-year period may locate a research report produced by a marketing research company that contains the sales information within a larger report that also discusses many other aspects of the market. However, many times those seeking research only require a very small portion of the report or small unit research information.

Small unit research information is represented by information of singular subject matter extracted or otherwise existing within a larger body of information (e.g., information fragments). By itself the context of small unit research information would not be sufficient to offer the necessary detail to fully understand the body of work from which it was drawn. Examples include: a statistic for a product's market share within a category, a chart showing growth of a disease, a one sentence comment or quote from a country's leader, or a 15-second video segment from a news source.

Within currently available means for acquiring research items, if a person conducting research only wants to acquire a small amount of information from an expensive marketing research report, such as a sales forecast, then being required to purchase the entire report in order to get only the sales forecast may not be practical and could be expensive.

In some instances, research suppliers offering information have begun to address the problem associated with the need to purchase the entire report by offering those seeking information the option of purchasing smaller sections or “slices” of the report. However, these sections often still contain much more information than is needed by someone who seeks only small unit research information.

For situations in which electronically delivered research information is available for purchase an option has not existed in which research information suppliers allow small unit research information to be purchased. However, recent developments of small unit purchase systems for electronically delivered products, particularly micropayment systems, have now made it possible for small unit research information to be sold.

Micropayments for small unit items provide a mechanism for keeping the cost of transactions low and thus allowing for electronic purchase in small denominations. For instance, in one widely used purchase application, micropayments permit users to make purchases of single songs that may be included within a larger collection of music (e.g., album or CD) at a small percentage of the cost of the full collection. Micropayment systems can exist in several forms that include using previously purchased stored value methods (e.g., payment cards) where a purchase reduces value from the stored product or pre-established micropayment accounts that may have a purchaser pay after the purchase.

While a number of previous inventions and proposed inventions have dealt with other issues related to one or more aspects of micropayments (U.S. Pat. No. 5,999,919 and U.S. Pat. App. No. 20020156696) and previous inventions have also focused on electronic delivery of other products such as music (U.S. Pat. No. 6,385,596 and U.S. Pat. App. No. 20010034705) prior art is lacking in addressing the issues raised in this invention.

The object of the present invention then is to present a method and system utilizing electronic and/or communications channels that allow users to acquire small unit research information. Additionally, the invention will allow characteristics of the purchase and delivery of small unit research information to be controlled by the method and system presented here.

Other objects and features of the invention and the manner in which the invention achieves its purpose will be appreciated from the foregoing and the following description and the accompanying drawings, which exemplify the invention.

### SUMMARY OF THE INVENTION

The present invention provides a method and system that allows a user to locate, select, purchase and receive delivery of small unit research information. Small unit research information relates to material used by a party in an effort to educate, understand, gain knowledge, comprehend, inform others or other criteria such as when a business professional uses the information within a business report. However, the present invention can be used in a plurality of other situations where the purpose is to educate, understand, gain knowledge, comprehend, and/or inform others.

In the preferred embodiment a user will gain access, through an interface device, to a research item information system that includes components and materials for locating, selecting, purchasing and receiving delivery of small unit research information. Small unit research information comprises information of singular subject matter extracted or otherwise existing within a larger body of information but by itself is not sufficient to offer the necessary detail to fully understand the body of work from which it was drawn. This information can be either located internally within the research item information system or external to the system and accessible via electronic and/or communications channel(s).

In this invention, the user performs activity to acquire small unit research information via an interface device connected to an electronic and/or communications channel(s). In the preferred embodiment the research item information system manages delivery to the user's interface device of multiple components including: 1) a research item locator component for locating, selecting and otherwise providing information related to small unit research information; 2) a transaction component for handling purchase of selected small unit research information; 3) a user activity storage component for tracking and storing the activity of a user within the research item information system; and 4) a research item delivery component for providing means of delivery of purchased small unit research information.

To enable purchase of small unit research information the invention provides access to elements to allow purchase transactions using micropayment transactions. Micropayments for small unit items provide a mechanism for keeping the cost of transactions low and thus allowing for electronic purchase in small denominations. Upon purchase the system manages the delivery of purchased small unit research information from its electronic and/or communications channel(s) location.

### BRIEF DESCRIPTION OF DRAWINGS

FIG. 1 shows a flow diagram offering a basic overview of this invention.

FIG. 2 shows a diagram of an additional presentation of the invention represented within technology components.

FIG. 3 illustrates the presence of multiple components within a user's interface device.

FIGS. 4A through 4D shows visual representations of components within a web browser.

FIG. 5 shows a flow diagram representing the initial steps involved in the process of locating, selecting, purchasing and receiving delivery of small unit research information.

FIG. 6 shows a flow diagram representing the steps involving the process of creating new stored user activity event.

FIG. 7 shows a flow diagram representing the steps in electronically purchasing small unit research information.

### DETAILED DESCRIPTION OF THE PREFERRED EMBODIMENT

Explanation of Research Item Information System

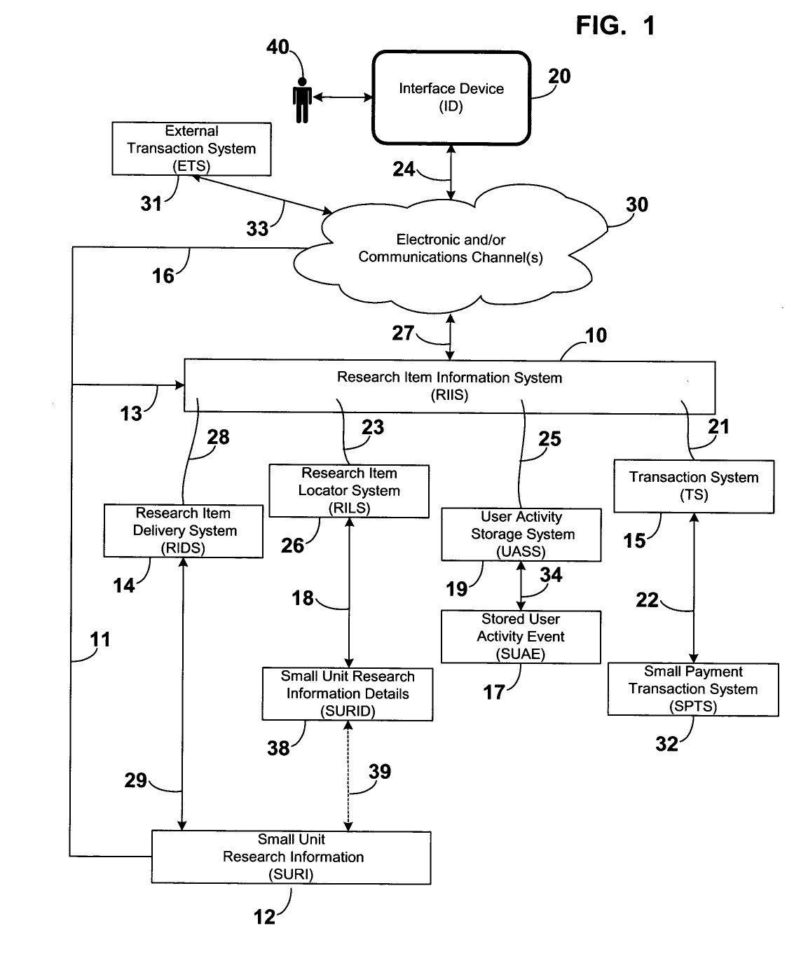

In the drawings, wherein like reference numerals indicate like elements, there is illustrated in FIG. 1 a flow diagram offering a basic overview of this invention. In the preferred embodiment, a user 40 will use an interface device (ID) 20 to access a research item information system (RIIS) 10 in which materials are provided for locating, selecting, purchasing, and delivering research information including small unit research information (SURI) 12.

SURI 12 is represented by information of singular subject matter extracted or otherwise existing within a larger body of information (e.g., information fragments). By itself the context of small unit research information would not be sufficient to offer the necessary detail to fully understand the body of work from which it was drawn. SURI 12 is provided by one party and delivered to another party, the user 40, for purposes desired by the user 40 (e.g., researchers, business professionals, students, etc.). SURI 12 may exist in: 1) a plurality of information item types (e.g., figures, statements, etc., 2) a plurality of items within each information item type (e.g., one or more figures, one or more statements, etc.); and 3) in a plurality of electronic or communications formats such as, though not exclusively, text, graphics, animation, interactive communication, video, audio, over-the-air transmission such as television and radio, tactile materials, olfactory materials, and other information formats.

For the purpose of this invention, the functions of the RIIS 10 include, but are not limited to:

providing a research item locator system (RILS) 26 that assists in managing search and selection activities for SURI 12;

providing a transaction system (TS) 15 that assists in managing purchase activity and provides access to a small payment transaction system (SPTS) 32 for small unit purchases;

providing a user activity storage system (UASS) 19 for recording and storing activity related to a user 40 who is performing activity within the RIIS 10; and

providing a research item delivery system (RIDS) 14 for managing delivery of purchased small unit research information to the user 40.

The functions of the RIIS 10 explained above are mentioned as these relate to the current invention. The RIIS 10 may by itself or as part of a system having greater functionality offer other functions most notably providing the necessary mechanisms to allow a user 40 to obtain large research items (e.g., full research reports).

### INVENTION OVERVIEW

Again referring to FIG. 1, the user 40 will access the RIIS 10 via an ID 20 that connects 24 to one or more electronic and/or communications channels 30, such as, but not exclusively, computer networks and sources such as Internet, Intranet, and other public and private networks; and/or digital and analog transmission networks and sources such as over-the-air broadcast sources, satellite sources and other wireless sources. Using the ID 20 a user 40, will gain access to the RIIS 10, which allows the user 40 to perform activities that include locating, selecting, purchasing and acquiring SURI 12. The RIIS 10, which connects 27 to one or more electronic and/or communication channels 30 may exist as a stand-alone item or may reside inside of other items such as software or sources used for assisting in research activities such as, but not limited to, libraries and online business websites, or may reside in software or at other sources that provide other purchase activity options such as, but not limited to, allowing for the purchase of other business items.

Locating and Selecting Small Unit Research Information

The process for acquiring SURI 12 begins with the RIIS 10 providing and managing delivery to the user's ID 20 of certain components including a component 23 containing the RILS 26 that includes features for locating and selecting the SURI 12. In particular, the functionality of the RILS 26, includes, but is not limited to, providing information regarding SURI 12 that are directly or indirectly created, referenced, linked or otherwise supplied by one party (e.g., research company) for the purpose of making available to another party (e.g., research user).

Upon user 40 search or location request the RILS 26 will locate information related to one or more SURI 12 that meets the requirements of the user's request. The information related to SURI 12 is contained within a small unit research information details (SURID) 38 component associated 18 with the RIIS 10, via the RILS 26. The SURID 38 contains information, references or characteristics related 39 to the SURI 12 including but not limited to information description, information format, the electronic and/or communications channel(s) location in which the SURI 12 resides, purchase availability and pricing. The user 40 will then have a choice to select from among the presented SURI 12 options or if no options are selected, the user 40 may choose to perform other activity such as, but not limited, to performing another search or location request.

Purchase and Delivery of SURI

The RIIS 10 contains 21 a TS 15 that includes features for allowing a user 40 to purchase or otherwise acquire one or more of the selected SURI 12. Associated 22 with the TS 15 is a SPTS 32 to assist with small payment or micropayment transactions. The TS 15, via the SPTS 32, may possess all elements necessary to complete transactions including small payment or micropayment transactions. These elements may reside directly within the RIIS 10 and its related components or certain elements may reside external to the RIIS 10 within one or more external transaction systems (ETS) 31. In situations in which ETS 31 is used, the RIIS 10, via the TS 15, which contains the SPTS 32, manages the relationship with the ETS 31. ETS 31 that may reside outside the RIIS 10 include but are not limited to micropayment service providers, financial transaction intermediaries, and other financial institutions.

Once the TS 15 has identified a completed transaction, the RIIS 10 provides delivery of the purchased SURI 12 via the RIDS 14 which is contained 28 within the RIIS 10. The RIIS 10 may offer several methods of delivery, including via postal mail or package delivery, however, in the preferred embodiment a method of electronic delivery is identified.

There are two options that may be available through the RIIS 10 for managing the electronic delivery of the SURI 12 to the ID 20. In option one, the SURI 12 follows a path 11 to 13 in which the SURI 12 is delivered directly through the RIIS 10 which then manages delivery of the SURI 12 through the RIIS's connection(s) 27 to an electronic and/or communications channel(s) 30 and then through this channel(s) to the user's ID 20 via the ID 20's connection(s) 24 to the channel(s) 30. In option two, the SURI 12 follows a path 11 to 16 in which the SURI 12 does not go through the RIIS 10 but goes through the electronic and/or communications channel(s) 30 and then to the user's ID 20 via its connection(s) 24 to the channel 30. It is important to note that with option two, it is possible that the SURI 12 will be delivered through an electronic and/or communications channel(s) 30 that differs from that to which the RIIS 10 is delivering other components.

The choice of delivery methods available to the RIIS 10, via the RIDS 14, depends on, but is not limited to: the electronic and/or communications channel(s) location(s) of the SURI 12; electronic and/or communication channel(s) or system conditions; or, if more than one option is available, the RIIS 10 may offer the user 40 a choice of delivery methods.

Within each delivery method the RIIS 10 may offer the user 40 additional delivery options. For example, the user could accept electronic delivery in the form that is visual within the same ID 20 option used to locate, select and purchase the SURI 12 (e.g., via web browser) or may choose a different method of delivery (e.g., file attachment to electronic mail delivery). Those skilled in the art will recognize that many other options are available.

Creating Stored User Activity Event

Once a user 40 has completed the actions required within the TS 15, containing the SPTS 32, (e.g., completed purchase), the RIIS 10 via the UASS 19 creates a stored user activity event (SUAE) 17 that stores 34 information related to the activities of the user 40 including user activity within the TC 15, the RILS 26 and the RIDS 14. Each SUAE 17 is assigned a unique identifier by the RIIS 10 and is stored by the RIIS 10, via the UASS 19, in a storage area that is associated with the RIIS 10.

Accessing and Modifying Stored User Activity Event

It is possible that the RIIS 10, via the UASS 19, will store user 40 information related to selected but not purchased SURI 12 made within the RILS 26. For instance, the SURI 12 may be selected at one point in time but the purchase is not made until a later point in time (e.g., days or weeks later). In this case the RIIS 10 will have required the user 40 be uniquely identify (e.g., user creates or enters username and password, web browser creates session identifier, etc.) at a point prior to exiting the RIIS 10. In this case the RIIS 10 via the UASS 19 will create a SUAE 17. The RIIS 10 may then allow the user 40 to retrieve the particular SUAE 17 or, upon a user's next accessing the RIIS 10, the RIIS 10 may automatically present to the user 40 one or more SUAE 17 that did not end in a purchase. The RIIS 10, via RILS 26, may then allow the user 40 to make modifications to the SUAE 17 including, but not limited to, adding additional SURI 12, deleting selected SURI 12 or changing other aspects of the SUAE 17 such has changing delivery options.

In this situation the RIIS 10 via the UASS 19 first locates the SUAE 17 and then the RIIS 10, via the RILS 26, manages delivery of information contained within the SUAE 17 through the RIIS's connection(s) 27 to an electronic and/or communications channel(s) 30 and then through this channel(s) to the user's ID 20 via the ID 20's connection(s) 24 to the channel(s) 30.

Overview Using Technology Components

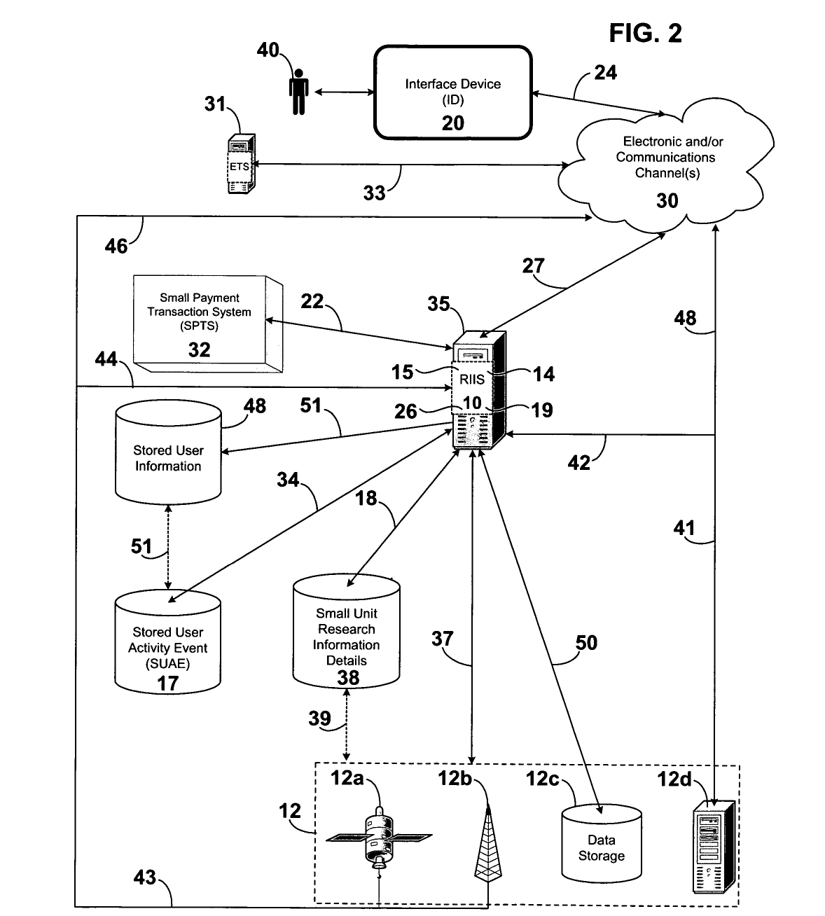

FIG. 2 offers an additional presentation of this invention represented within technology components. The user 40, through an ID 20 accesses, via an electronic and/or communications channel(s) 30, the RIIS 10 that resides within equipment containing an information technology processor 35. The RIIS 10 contains the required electronic components and tools for allowing a party to locate, select, purchase and receive delivery of SURI 12 including the RILS 26 and the TS 15.

The process that allows a user 40 to acquire SURI 12 includes the RIIS 10 providing and managing delivery to the user's ID 20 of a component containing the RILS 26, which allows the user 40 to locate and select information related to SURI 12. Information related to SURI 12 is contained within a SURID 38 and is delivered from its electronic and/or communications channel(s) location(s) that is associated 18 with the RIIS 10, via the RILS 26. The SURID 38 contains information, references or characteristics related 39 to the SURI 12. This information, references or characteristics allow the RIIS 10, via the RILS 26, to offer functionality that will enable the user 40 to locate (e.g., search) SURI 12 and then select the desired SURI 12. However, the actual SURI 12 may reside in other locations.

Locations of Small Unit Research Information

There are numerous sources in which the SURI 12 may reside. These sources include, but are not limited to: a file location(s) that is (are) directly associated with the RIIS 10 such as files stored on data storage devices 12c associated 50 with the RIIS 10 or its related programs and applications; a file location(s) that is (are) outside the location(s) of the RIIS 10 such as, but not exclusively, those located on Local Area Networks, Internet, Intranets, and/or Extranets 12d; communication or frequency location(s) 12b, such as, but not exclusively, radio, television, cellular or other analog or digital communications that are either delivered directly over-air or by wireless means or through wireline hookup; or information provided via satellite communications 12a either delivered directly over-air or by wireless means or through wireline hookup.

Acquisition of Small Unit Research Information

Once the user 40 has located and selected the SURI 12 within the RILS 26, the user may then acquire the SURI 12 via the TS 15. The TS 15 includes a component that allows for electronic purchases of small unit research information via processes commonly referred to as micropayment transactions. Micropayments for small unit research information provide a mechanism for keeping the cost of electronic transactions low and thus allowing for electronic purchases in small denominations. Mechanisms for handling electronic micropayments are provided in several computer programming variations that are familiar to those skilled in the art and include but are not limited to XML and Java. Additionally, many financial vendors provide micropayment programming or financial service packages that can be associated with the current invention.

As shown in FIG.2, the options in which the TS 15 incorporates micropayment transactions include but are not limited to: 1) the TS 15, via its associated 22 SPTS 32, may handle all transaction related processing that is related to user 40 purchase activity, or 2) the TS 15, via the SPTS 32, may connect through the RIIS 10 connection(s) 27 to an electronic and/or communications channel(s) 30 and then through a connection 33 to an ETS 31. The ETS 31 may handle some or all of the financial activities associated with user 40 purchase activities. Whether the ETS 31 handles some or all of the processing, the ETS 31 communicates the necessary information related to the purchase made by the user 40 back to the RIIS 10 through the ETS 31 connection 33 to the an electronic and/or communications channel(s) 30 and then through this channel(s) and the to the RIIS 10 via its connection 27 to the electronic and/or communications channel(s) 30.

The RIIS 10, via the TS 15, may require the user to provide additional information in order to utilize the purchase processing capabilities contained within the TS 15. For example, the user may be required to provide financial related information (e.g., micropayment account information, stored value product information, other financial information) that permits the user 40 to make purchases for small unit research information. Such information may be input via one of the input mechanisms that may be associated with the ID 20.

It should be noted that during the process to acquire the selected SURI 12, the RIIS 10 may require the user 40 to perform other activities to complete the purchase process. The activities may include but are not limited to: 1) having the user 40 review the selected items and de-select items that may no longer be of interest for purchase; 2) having the user 40 uniquely identify themselves (e.g, create new account, enter unique identifier for existing account), and 3) have user 40 make choices regarding account setup such as billing information. At some point during the transaction process the user 40 may be presented with options for receiving the purchased SURI 12.

Delivery of Information Content

The RIIS 10, via the RIDS 14, manages delivery of the SURI 12. In the preferred embodiment the RIIS 10, via the RIDS 14, manages delivery via an electronic or communication channel(s), however, other methods of delivery, such as but not exclusively, postal or package delivery are conceivably available. The path of delivery of the SURI 12 to the user's ID 20 may occur in one of the following ways:

having the SURI 12 delivered from an electronic and/or communications channel(s) location(s) stored on a data storage device(s) 12c associated 50 with the RIIS 10 or its related programs and applications, through a path that begins from the storage device(s) 12c through the association 50 between the RIIS 10 and the storage device 12c, through the RIIS 10 located in the technology processor 35, through a connection(s) 27 linking the technology processor 35 containing the RIIS 10 to the electronic and/or communications channel(s) 30, and then to the user's ID 20 through a connection(s) 24 linking the ID 20 to the electronic and/or communications channel(s) 30;

having the SURI 12 delivered from an electronic and/or communications channel(s) location(s) 12d that include, but are not limited to those located on Local Area Networks, Internet, Intranets, and/or Extranets, through a path 41 to 48 linking the location(s) 12d of the SURI 12 to the electronic and/or communications channel(s) 30, and then to the user's ID 20 through a connection(s) 24 linking the ID 20 to the electronic and/or communications channel(s) 30;

having the SURI 12 delivered from an electronic and/or communications channel(s) location(s) 12d that include, but are not limited to those located on Local Area Networks, Internet, Intranets, and/or Extranets, through a path 41 to 42 connecting the location(s) of the SURI 12 to the RIIS 10, then through a connection(s) 27 linking the technology processor 35 containing the RIIS 10 to the electronic and/or communications channel(s) 30, and then to the user's ID 20 through a connection(s) 24 linking the ID 20 to the electronic and/or communications channel(s) 30;

having the SURI 12 delivered from other electronic and/or communications channel(s) location(s) 12a and 12b such as, though not exclusively, satellite, broadcasting and wireless connections, through a path 43 to 44 connecting the location(s) of the SURI 12 to the RIIS 10, then through a connection(s) 27 linking the technology processor 35 contain the RIIS 10 to the electronic and/or communications channel(s) 30, and then to the user's ID 20 through a connection(s) 24 linking the ID 20 to the electronic and/or communications channel(s) 30; or

having the SURI 12 delivered from other electronic and/or communications channel(s) location(s) 12a and 12b such as, though not exclusively, satellite, broadcasting and wireless connections, through a path 43 to 46 linking the electronic and/or communications channel(s) location(s) of the SURI 12 to the electronic and/or communications channel(s) 30, and then to the user's ID 20 through a connection(s) 24 linking the ID 20 to the electronic and/or communications channel(s) 30.

Path of User Activity

Activity associated with a user 40 in locating, selecting, purchasing and receiving delivery of SURI 12 travels a path from the ID 20 through a connection(s) 24 between the ID 20 and the electronic and/or communication channel(s) 30, then through a connection 27 linking the electronic and/or communications channel(s) 30 with technology processor 35 containing the RIIS 10. The RIIS 10 then directs the user's activity to the appropriate areas controlled by the RIIS 10.

Information Related to User's Interface Device

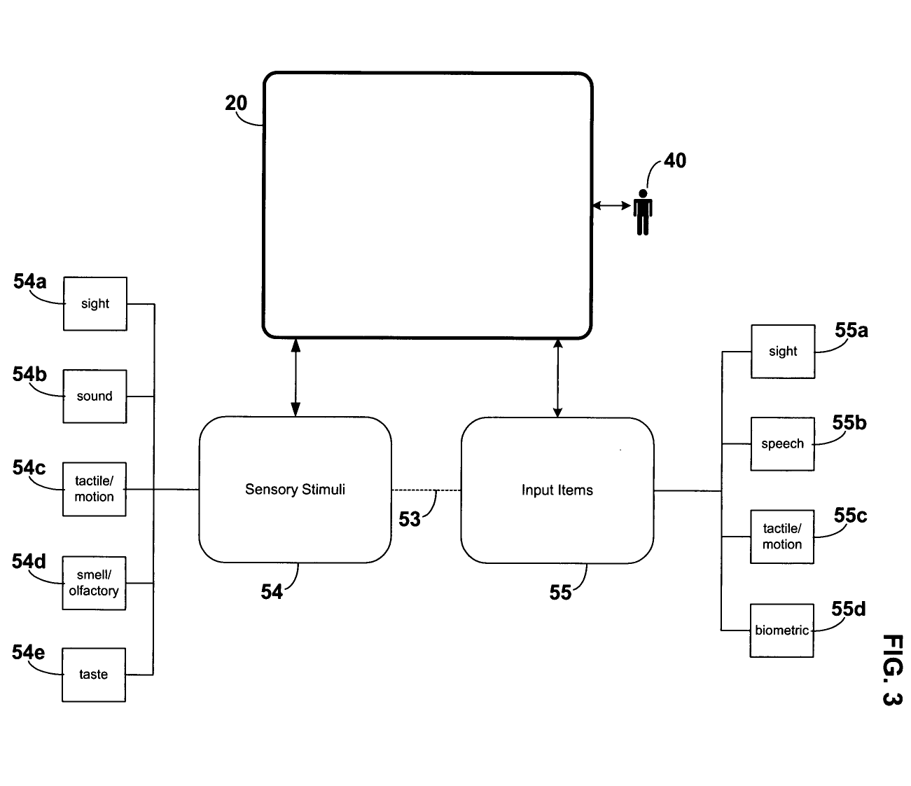

FIG. 3 provides more detail on user 40 activity via the user's interface device 20 and on the RIIS's management of information delivery. The user's ID 20 can be thought of as all connected, interrelated or otherwise associated equipment or devices that allow a user to experience and/or interact with available, authorized and/or otherwise accessible resources available through an electronic and/or communications channel(s). The user's experience within the ID 20 can be divided into two distinct though interrelated 53 elements.

The user 40 can provide information to the RIIS 10 via input items 55 that connect the user 40 to the interface device. Such interactive items associated with the ID 20 generally fall, though not exclusively, into items that allow for user 40 interactivity such as those dealing with sight 55a, speech 55b, touch/motion 55c and biometrics 55d. Such items may include, but are not limited to: computer keyboards; other computer input items such as a mouse, scanning devices, input pads or sticks; pupil or eye trackers; remote control devices; and touch sensors.

The ID 20 is also the mechanism through which components managed by the RIIS 10 and results of processes undertaken by these components are delivered to the user 40. In the preferred embodiment the RIIS 10 manages the delivery of information within the ID 20, though for delivery of user 40 purchased SURI 12 other delivery modes are possible such as, but not limited to, postal and package delivery. Information whose delivery is managed by the RIIS 10 can potentially exists in the form of one or more sensory stimuli 54 that the user 40 derives from simply being within the presence of the interface device. The sensory stimuli that impact the user's senses include the presence of one or more stimuli dealing with sight 54a, sound 54b, tactical/motion 54c, smell/olfactory 54d, and/or taste 54e. Consequently, the ID 20 through which the RIIS 10 manages delivery may include, but are not limited to: video screens such as computer, wireless devices and television screens; video projection machines; audio or sound apparatus; scent emitters; items producing vibration or motion; and taste providers.

Potential Other Items Within RIIS

Once again referring for FIG. 2, in addition to containing the components RILS 26, TS 15, UASS 19 and RIDS 14, the RIIS 10 may also contain additional information and tools within each component, such as but not limited to: 1) tools or information that provide assistance, suggestions, instructions and descriptions to the user 40 as they experience the material presented within the ID 20; 2) details or other information regarding the SURI 12 including its electronic and/or communications channel(s) location(s); 3) providing access to translation tools for translating SURI 12 or other information; 4) summarization or tracking tools allowing for automatic summarization or categorization of material or activity that the user 40 experiences within the ID 20; 5) tools for providing user 40 with suggestions such as SURI 12 options, search assistance, financial information and reminders, and 6) information and tools for allowing user 40 to navigate to other areas within the RIIS 10.

Performing Activity Within the Interface Device

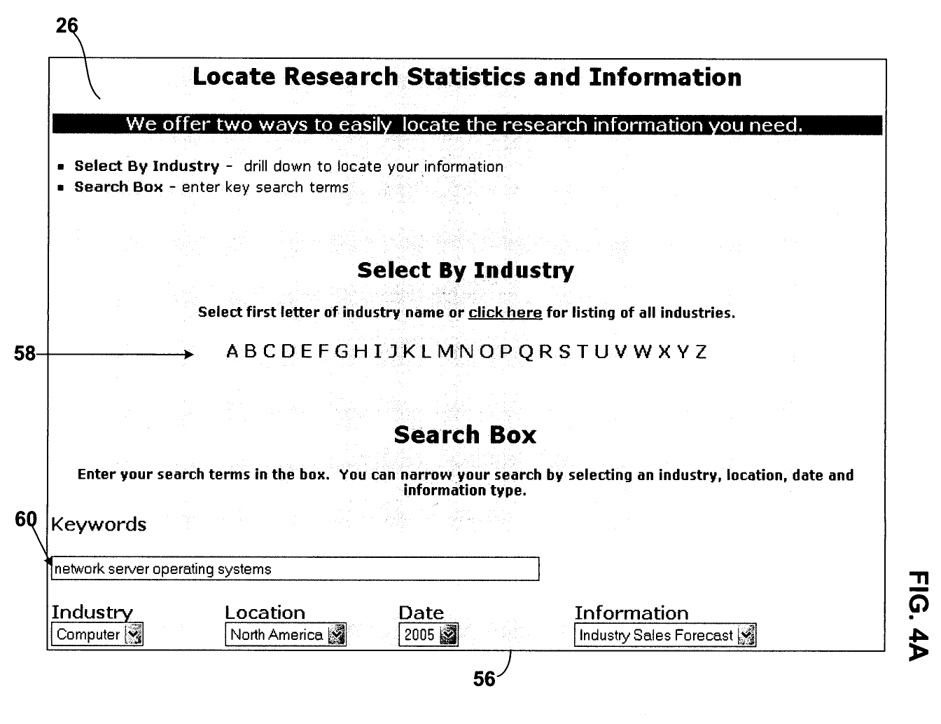

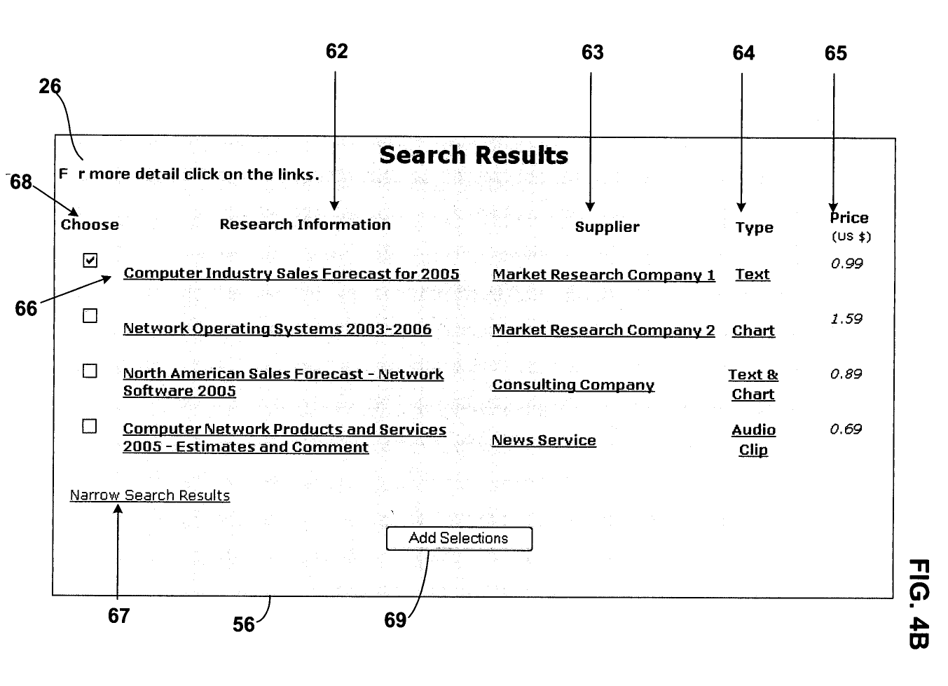

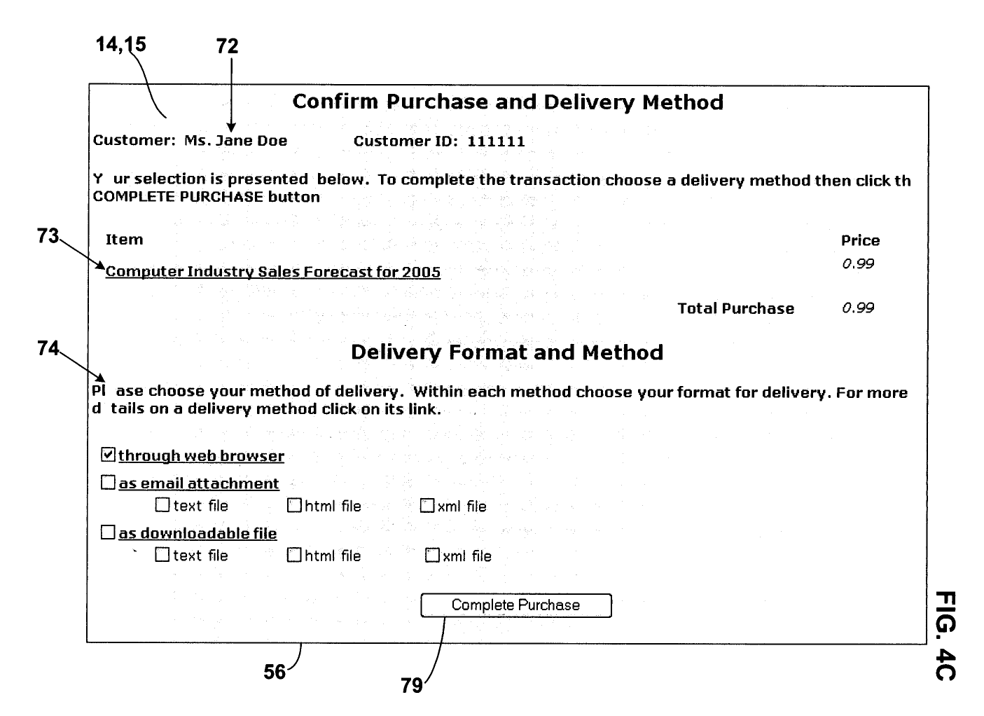

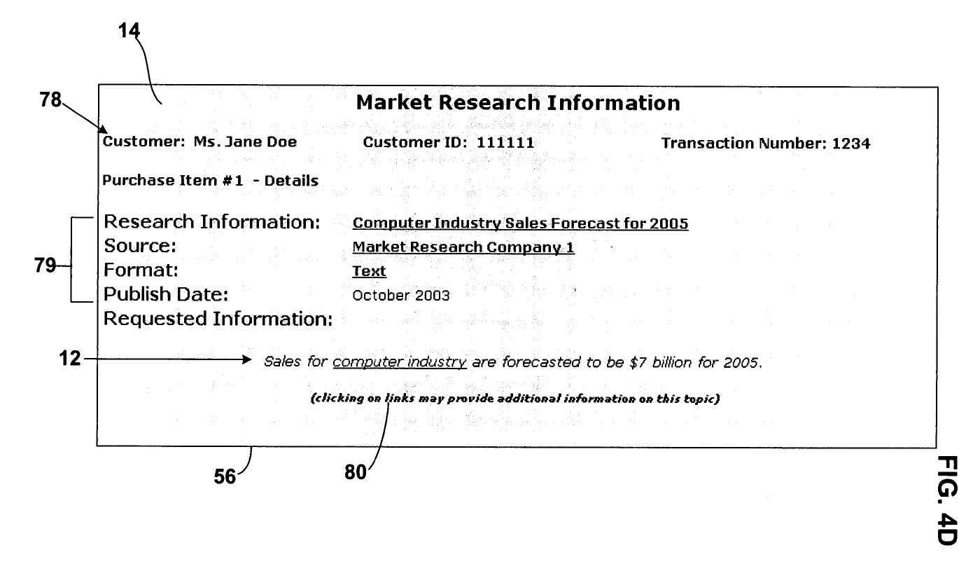

FIG. 4A through FIG. 4D presents a visual representation of the process for locating, selecting, purchasing and receiving delivery of SURI 12. Now referring to FIG. 2 and FIG. 4A, the RIIS 10 manages delivery to the user's ID 20 of multiple components, with one component being the RILS 26 which assists a user 40 in locating and displaying results of a search for SURI 12. FIG. 4A shows one embodiment for assisting a user 40 in locating SURI 12. In this example the RIIS 10 manages delivery of components managed by the RIIS 10 through electronic and/or communications channel(s) that utilize protocols associated with the World Wide Web. In this environment the elements of the RILS 26 are presented within a web browser, though other methods may be available through which the RIIS 10 manages delivery of the RILS 26 or other components managed by the RIIS 10.

As shown in FIG. 4A, a web browser 56 is presented which contains information whose delivery is controlled by the RIIS 10. The representation shows the RILS 26 and certain elements contained within the RILS 26. For instance, in this representation a user 40 is offered several options for locating SURI 12 including an option 58 that allows the user to select alphabetically or an option 60 that allows a user 40 to enter search keywords. This representation is for demonstration purposes only and those skilled in the art will recognize that other representations may be possible for allowing a user 40 to locate or otherwise search for SURI 12.

FIG. 4B shows the results of the user's SURI 12 location or search activity within a web browser 56. Now looking also at FIG. 2, in the representation in FIG. 4B, the RIIS 10, via the RILS 26 and drawn from its associated 18 SURID 38 component, presents the user 40 with information resulting from the user's location or search activity. This information may include, but is not limited to, descriptive information related to the SURI 12 meeting the user's location or search criteria such as title 62, SURI 12 supplier 63 and SURI 12 format 64 as well as acquisition information such as cost 65 for acquiring. Additionally the RILS 26 may present methods for: 1) allowing the user 40 to gain additional information 66 on each SURI 12 option (e.g., click on hyperlinks to see more detail), 2) allow user 40 to modify location and search activity 67 such as, but not limited to, performing a more narrow or broader search, and 3) allowing the user 40 to select 68 one or more of the presented SURI 12 for potential purchase. FIG. 4B shows the selection of a single item. If desired the user 40 could choose to add 69 this item for potential purchase. Once added the RIIS 10 will manage the process for allowing purchase of SURI 12.

FIG. 4C shows, within a web browser 56, the results of the user's decision to move to the purchase stage of the process. In this representation the RIIS 10, via the TS 15 and also via the RIDS 14, presents the user 40 with information and options related to purchase and delivery. This information may include, but is not limited to, customer identification information 72, details of the user's selection for purchase 73 and user selection for choice of delivery options 74. It should be noted that it is also possible that information related to delivery may reside separately from purchase information, for instance, may appear on a different screen. Once the user 40 is satisfied with the selected SURI 12 they may proceed 79 with activities needed to complete the transaction.

FIG. 4D shows, within a web browser 56, the results of the electronic delivery of the purchased SURI 12 by the RIIS 10, via RIDS 14. Now looking also at FIG. 2, the RIIS 10, via the RIDS 14, has managed the electronic delivery of the SURI 12 from its location 12a, 12b, 12c or 12d, to the user's ID 20. The delivered SURI 12 appears in the user's web browser 56 since this delivery option was previously selected as shown in FIG. 3C. However as noted, the delivery could also be accomplished using other electronic and non-electronic delivery methods.

The information presented in the electronic delivery may include, but is not limited to, customer identification information 78, information related to the characteristics 79 of the purchased SURI 12, and the SURI 12 itself. Also, it is possible additional information or options can be provided such as, but not limited to, the ability to provide details 80 related to the purchased item. Conceivably many more options could also be provided within the the process of delivering the SURI 12 including but not limited to: 1) links or references to other related SURI 12; 2) links or navigation to options within the RIIS 10; and 3) options to provide the SURI 12 in other formats.

The representation shown in FIG. 4D shows that the information presented to the user 40 within their ID 20 may consist of more than two separate sources. For instance looking at FIG. 4D and FIG. 2, the SURI 12 may be delivered from 12d through a path 41 to 48 linking the location(s) of the SURI 12 to the electronic and/or communications channel(s) 30, and then to the user's ID 20 through a connection(s) 24 linking the ID 20 to the electronic and/or communications channel(s) 30. In this way the RIIS 10 manages the delivery of the SURI 12 within the user's ID 20 but the SURI 12 presented in the user's ID 20 resides at one location (e.g., 12d) while the other information presented in the ID 20 such as but not limited to the customer information 78 and information characteristics 79 reside at another location (e.g., components associated with RIIS 10).

The representations using web browsers shown in FIG. 4A, FIG. 4B, FIG. 4C and FIG. 4D, while useful for effectively understanding the invention, is not limited to these embodiments since other methods may also be employed that do not use a web browser page 56 for delivering the information to the user 40. The representation within the web browser 56 also assumes the possible presence of other items associated with the interface device that involve sensory experience and input. For instance, in this representation the user 40 is locating and purchasing SURI 12 using an interface device(s) connected to an electronic and/or communications channel(s). The user interacts with the interface device via input devices that include a keyboard and a computer mouse and, in addition to visual stimuli, may also receive stimuli from other sources such as via audio and motion.

These representations are not intended to show the entire process for locating, selecting, purchasing and receiving delivery of SURI 12, rather, the intention of the representations is to isolate and describe certain aspects of the invention in order to convey basic understanding.

Other Arrangement of Components

It should be noted that in FIG. 4A, FIG. 4B, FIG. 4C and FIG. 4D the arrangement of components controlled by the RIIS 10 provided within the user's ID 20 represent only one of a plurality of arrangements of components, which are potentially available since there are numerous interface device options that can handle a plurality of different stimuli types and offer a plurality of input devices. For instance, while FIG. 4A, FIG. 4B, FIG. 4C and FIG. 4D show a horizontal arrangement with elements of components associated with the RIIS 10, it is conceivable that components could be presented vertically. Clearly additional arrangements are possible including those that involve only partial or no visual stimuli. For instance, audio methods may be used to present the SURI 12, with the audio being produced within the ID 20 through an audio producing device such as audio speakers. In this embodiment some elements of the SURI 12 may appear on a computer screen (e.g., identification information for an audio research item) while the main aspects of the SURI 12 is delivered through audio means (e.g., person speaking the research item). Or to extend this example further, the user could utilize voice recognition technology as an input method.

Creating Stored User Activity Event

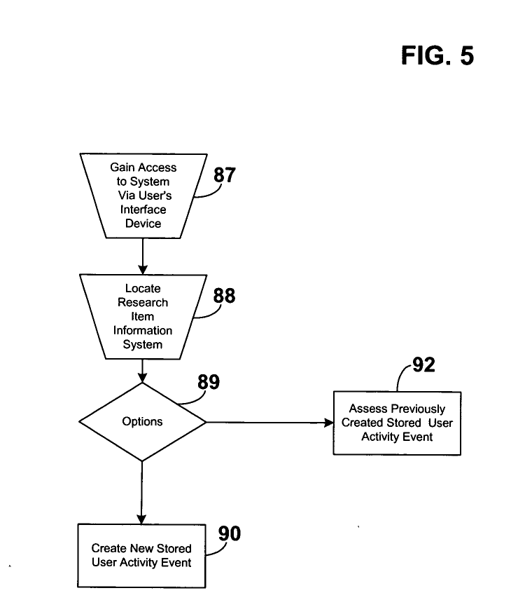

FIG. 5 shows a flow diagram representing the initial stages in the creation of a stored user activity event. The stored user activity event results will occur based on activity performed by a user within the research item information system. The diagram shows several steps that reflect the flow of information that occurs in order to create or modify a stored user activity event. Now relating information in FIG. 2 with the information in FIG. 5, the user 40 begins the process by gaining access 87, via the ID 20, to the system in which the RIIS 10 is contained.

The RIIS 10 may operate as a stand-alone item that is accessed directly or may reside within a more complex offering requiring the user 40 to maneuver to the section containing the RIIS 10. In either situation the user 40 must locate 88 the RIIS 10. It is possible that gaining access to the RIIS 10 may require the user 40 to first enter information that would uniquely identify the user 40 (e.g., username and password). However, while unique identification is required in order for the user 40 to purchase the SURI 12, the location at which this process takes place does not necessarily occur at the steps shown in FIG. 5.

Once the user 40 has completed all tasks needed to gain access, the RIIS 10 may present the user 40 with certain options 89 which may include creating a new stored user activity event 90 or modifying an existing stored user activity event 92. The action of locating existing stored user activity event may be passive, in that the RIIS 10 will identify the stored user activity event upon the user's entry into the system or may require user 40 action to locate the stored user activity event.

Creating New Stored User Activity Event

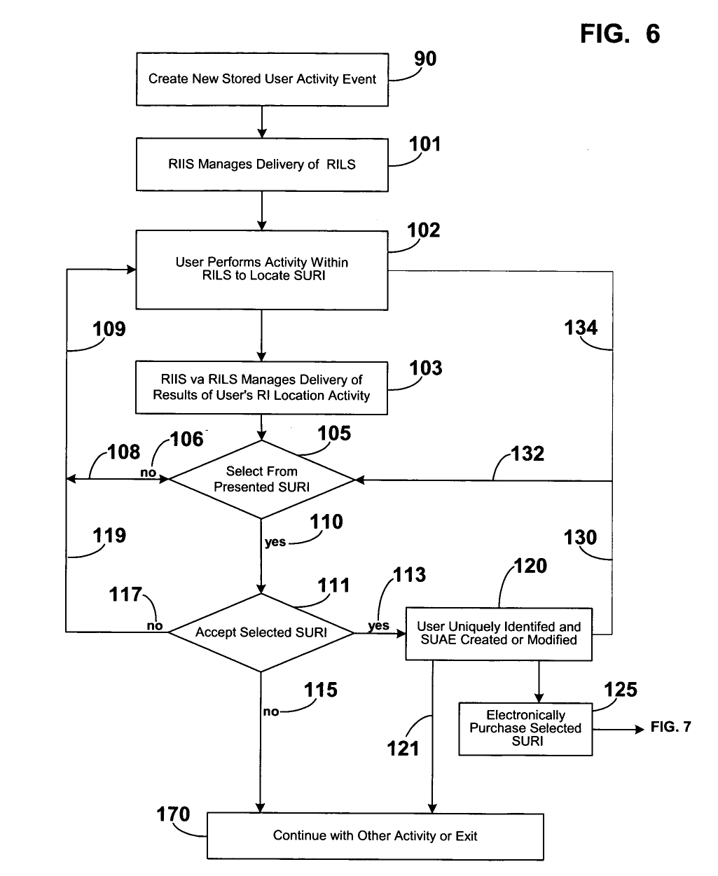

FIG. 6 shows a flow diagram representing the steps carried out in the process of creating a new stored user activity event 90 once the user has located the research item information system. Now relating FIG. 2 with FIG. 6, to create new SUAE 17 the RIIS 10 manages delivery 101 of the RILS 26. The RILS 26 contains information related to SURI 12 within a SURID 38 that is associated 18 with the RIIS 10, via the RILS 26. The information related to the SURI 12 contained in the SURID 38 includes, but is not limited to SURI 12 information description, SURI 12 information format, the electronic and/or communications channel(s) location in which the SURI 12 resides, purchase availability and pricing.

Next the RIIS 10 permits the user 40 to perform activity 102 within the RILS 26 for locating and otherwise searching for SURI 12. The SURI 12 location efforts of the user 40 leads to the RIIS 10 managing delivery 103 to the user ID 20 of results of the user's SURI 12 location efforts. These results may exist in one experience within the ID 20 (e.g., on single page) or may exists within multiple ID 20 experiences (e.g., user may need to view several pages). The results provided within the delivery managed by the RIIS 10 within the RILS 26 may include information related to one or more SURI 12 but does not contain the SURI 12 itself.

With the basic information related to one or more SURI 12 available through the user's ID 20, the RIIS 10, via the RILS 26, may present the user 40 with the option 105 to select one or more SURI 12 from the choices presented. If a user chooses not to select 106 from the presented options the RIIS 10, via the RILS 26, may allow 108 to 109 the user 40 to perform new SURI 12 location activities 102.

If the user 40 chooses the option 110 to make a selection from the presented SURI 12 options, the RIIS 10, through the RILS 26, may offer the user 40 the option 111 to accept the selected SURI 12. If the user 40 accepts 113 the selected SURI 12 the RIIS 10 begins the process for allowing the user 40 to purchase the selected SURI 12. This process begins 120 with the RIIS 10, via the UASS 19, requiring the user 40 to be uniquely identified (e.g., username and password). For new users 40 this may mean creating new user information while existing users may simply need to enter an existing identifier. In either case the information is either added, retrieved or updated within a storage area 48 associated 51 with the RIIS 10, via the UASS 19. It should be noted that this storage area 48 may also be accessible 51 to the RIIS 10 for other purposes related to the customer. Once the user is uniquely identified the RIIS 10, via the UASS 19 creates a SUAE 17 that is associated 51 with the uniquely identified user.

Alternatively, the user 40 who wishes not to accept 117 the selected SURI 12 may be permitted to modify the selections in which case the RIIS 10, via the RILS 26 will return 119 to 108 the user 40 to the point 105 at which SURI 12 was selected. The user 40 may then choose to modify selection decisions or the RIIS 10, via the RILS 26, may allow 119 to 109 the user 40 to perform new SURI 12 location activities 102.

A third option 111 for the decision to accept the selected SURI 12 may allow the user to not accept 115 and instead continue with other activity or exit the system 170.

Once again referring to FIG. 2 and FIG. 6, once the SUAE 17 is created 120, the RIIS 10 provides the user 40 with several options. First, the user 40 may be permitted to purchase 125 the selected SURI 12. Second the RIIS 10 may permit the user 40 to modify the selections contained within the SUAE 17 in which case the RIIS 10, via the RILS 26 will return 130 to 132 the user 40 to the point 105 at which SURI 12 was selected. The user 40 may then choose to modify selection decisions or the RIIS 10, via the RILS 26, may allow 130 to 134 the user 40 to perform new SURI 12 location activities 102. It should be noted that modifications that occur to existing SUAE 17 would be reflected in an updated SUAE 17. Third the user 40 may choose 121 not to perform modification or purchasing activities at this time and instead continue 121 with other activity or exit the system 170.

Purchasing Selected Small Unit Research Information

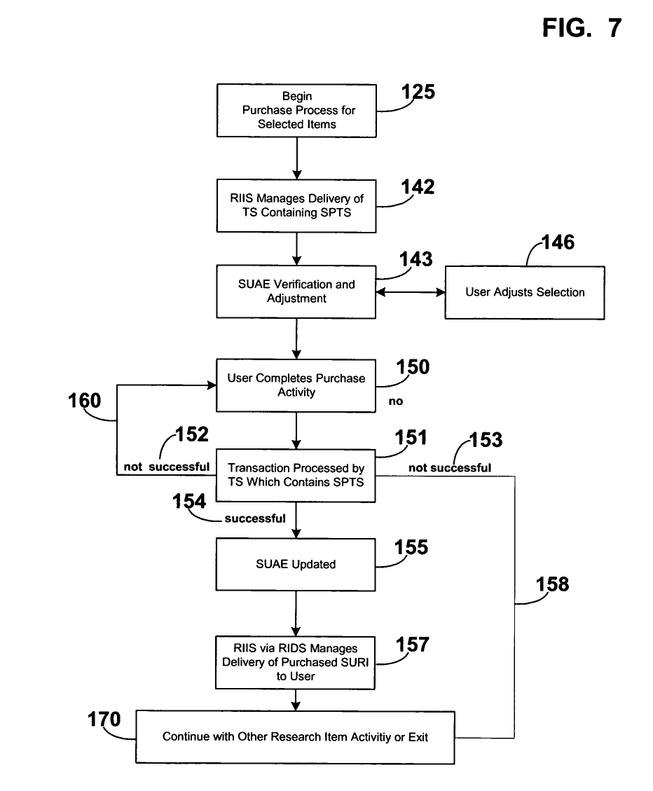

FIG. 6 indicates that the RIIS 10 offers the user 40 the ability to electronically purchase 125 the selected SURI 12. The process for electronically purchasing the SURI 12 is presented in FIG. 7 which shows a flow diagram representing the steps carried out in the process of allowing the user 40 to make electronic purchases of small unit research information that are contained within a specified stored user activity event. Now referring to FIG. 2 and FIG. 7, the RIIS 10 manages delivery 142 to the user's ID 20 of component TS 15 for handling purchase transactions. Contained within the TS 15, is the SPTS 32, which offers users 40 the ability to make electronic purchases of small unit research information. Next the TS 15 may offer the user 40 the ability to verify and adjust 143 the SUAE 17, which contains information on the selected SURI 12, for which a purchase is to be made. Here the RIIS 10 may allow the user 40 to not only adjust 146 the current SUAE 17 but if a uniquely identified user 40 is associated with more than one SUAE 17 for which a purchase as not previously been made then the RIIS 10, via the TS 15, may allow the user 40 to choose one, more than one or all unpurchased SUAE 17 for purchase within a single purchase transaction.

Once one or more SUAE 17 have been selected the RIIS 10, via the TS 15, allows for the user 40 to performs the necessary activity 150 to process the electronic purchase transaction. This activity involves user 40 input via the ID 20. Input may include, but is not limited to, providing information to insure unique identification (e.g., creating new account, entering existing account information) and providing other transactional information (e.g., entering stored value card information, entering financial account information).

Once user 40 activities necessary for processing the electronic purchase transaction has been initiated, the RIIS 10, via the SPTS 32 contained within the TS 15, processes the transaction 151. As previously discussed the RIIS 10 via the TS 15 which contains the SPTS 32, may possess all elements necessary to complete transactions including small payment or micropayment transactions. These elements may reside directly within the RIIS 10 and its related components or certain elements may reside external to the RIIS 10 within one or more ETS 31. In situations in which ETS 31 is used, the RIIS 10, via the TS 15, which contains the SPTS 32, manages the relationship with the ETS 31. ETS 31 that may reside outside the RIIS 10 include but are not limited to micropayment service providers, financial transaction intermediaries, and other financial institutions.

If the electronic transaction process is successful 154 the RIIS, via the UASS 19 updates 155 the SUAE 17 for which purchase is associated. Then the RIIS 10, via the RIDS 14 manages the delivery 157 of the purchased SURI 12 to the user. In the preferred embodiment electronic methods are used to deliver the purchased SURI 12, though other methods such as, but not limited to, postal and package delivery are possible. The selection of delivery methods may be identified by the user 40 in one of many areas of the process. Once the transaction is complete the user 40 may continue with other activity or exit the system 170.

If the transaction process 151 is not successful the RIIS 10 may offer two options to the user 40. One option if not successful 152 follows the path 160 that allows the user 40 to modify the purchase process activity 150 to correct potential error or problems that resulted in an unsuccessful transaction. A second option if the transaction process 151 is not successful 153 follows the path 158 that allows the user 40 to continue with other activity or exit the system 170.

Modify Stored User Activity Event

Now referring to FIG. 6 and FIG. 2, a user who has created a stored user activity event may choose 121 to not purchase the selected SURI 12 at a point in time. However, the RIIS 10, via the UASS 19, may allow the user's information to be stored 48 and made accessible to the user 40 at a later time. As shown in FIG. 5, upon gaining access to the RIIS 10, the user 40 will be presented with the option 89 to access previously stored 92 SUAE 17, including those SURI 12 that were selected but not purchased.

The RIIS 10, via the RILS 26, allows the user to make modifications to the selected, SUAE 17. Now referring to FIG. 6, the RIIS 10, via the RILS 26, in effect presents the user 40 at step 111. The process for completing the tasks follows the same process as was shown in FIG. 6. It should be noted that the user 40 may delete or remove the SUAE 17 at 117. Also, the RIIS 10 may also contain mechanism that may under certain conditions (e.g., length of user inactivity) automatically delete a user's SUAE 17.

### OTHER EMBODIMENTS

It will be appreciated by those skilled in the art that the foregoing has set forth the presently preferred embodiment of the invention and an illustrative embodiment of the invention, but that numerous alternative embodiments. For example, in addition to the RILS 26, the TS 15, the RIDS 14 and the UASS 19, the RIIS 10 may manage additional components that assist in the process of locating, selecting, purchasing, and delivering small unit research information. For instance, the RIIS 10 may contain a component that allows for advertising or promotional messages to be displayed within other components managed by the RIIS 10.

Also, referring to FIG. 2, the current preferred embodiment shows the RIIS 10 resides within equipment containing an information technology processor 35 that is accessible via an electronic and/or communications channel(s) 30. In another embodiment, the RIIS 10 and its associated components such as, but not exclusively, the RILS 26 and the TS 15, may reside within equipment containing an information technology processor that is associated with the user 40. For example, the RIIS 10 may reside on the user's computer. In this case access to the RIIS 10 need not require access over an electronic and/or communications channel(s) 30. However, while in this embodiment access to the RIIS 10 does not occur over an electronic and/or communications channel(s), access to an electronic and/or communications channel(s) may be required in order for the RIIS 10 to carry out certain functions, most notably, managing the delivery of the SURI 12. This would be the case unless all SURI 12 rest on equipment or components that are associated with the equipment containing the RIIS 10 and that do not require the use of an electronic and/or communications channel(s) to access.

Also, an embodiment may exist in which the RIIS 10 must communicate with information related to the user's ID 20. For instance, the user's ID 20 may contain information related to the micropayment transaction. For example, the RIIS 10, via the TS 15 and it component the SPTS 32, may provide an option that requires access to the user's ID 20 in order to complete the transaction. This might be the case if the user's ID 20 contains a stored value mechanism for assisting with purchase activity. Also, the RIIS 10 may communicate with the user's ID 20 for purposes of assisting with unique identification such as, but not limited to, writing and reading identifier information (e.g., cookies) to the user's ID 20.

Also, an embodiment may exist in which the RIIS 10 tracks other user activity within the components managed by the RIIS 10. Examples may include but are not limited to: 1) monitoring click behavior; 2) measuring usage time within a component; and 3) monitoring number of visits or re-visits to a component.

Also, an embodiment may exist in which the user may consist of multiple users that are working together or in a collaborative way to create stored user activity event. In this case the RIIS 10, via its components, may offer collaboration tools and methods such as, but not limited to, file sharing, real-time discussion, and other interactive communication methods.

Also, an embodiment may exist in which the user may be classified as belonging to a group of other users, such as being members within a single large user. For example, a large user may be a corporation or library. In this case, the RIIS 10, via its components, may track and store information related to individual users and combine or aggregate individual user information for information on the larger user to which the individual users are associated.

Also, an embodiment may exist in which the RIIS 10, via the TS 15, requires the user 40 to perform certain activities in a preplanned arrangement. For instance, the RIIS 10, may require that the user 40 complete activity within the RIIS 10 and its related components (e.g., watch a video, affirm understanding of purchasing terms, etc.) prior to allowing the user to complete activity (e.g., make purchase).

Conclusion, Ramification and Scope

The present invention provides a method utilizing electronic and/or communications channel(s) for allowing a user to locate, select, purchase and receive delivery of small unit research information. Such a method takes advantage of methods of micropayment that allow a user to affordably purchase small unit research information while experiencing low costs of transactions. In the absence of such a method those locating, selecting, purchasing and receiving delivery of small unit research information over electronic and/or communications channel(s) face problems. These disadvantages primarily occur due to the requirement that users purchase larger units of research information often containing additional information that is not needed. For example, existing methods may require the user to spend large sums to purchase an entire report of which the user may only need one statistic. For many the cost of acquiring the needed research may be prohibitive. Consequently the required research may not be obtainable which potentially results in research problems for the user.

The current invention addresses the disadvantages of existing methods for locating, selecting, purchasing and receiving delivery of small unit research information over electronic and/or communications channel(s) by providing means for allowing purchase of selected small unit research information via micropayment transactions. Thus, potential advantages of this invention include, but are not limited to: access to only the research items needed, affordable transaction fees, increased convenience and greater satisfaction for users requiring the small unit research information. In addition, it is conceivable that the availability of the small unit research information for a relatively small cost will bolster research activities of wide range (e.g., socially, economically) of researchers, business professionals and students who otherwise would not have access to the research items.

1. A method for a user to locate, select, purchase and receive delivery of small unit research information consisting of:
providing access through a user's interface device to a research item information system;
managing the delivery to said user's interface device of multiple components including a research item locator component for allowing said user to locate small unit research information, a transaction component to allow purchase of said small unit research information; and a delivery component to allow said user to acquire or otherwise receive said small unit research information;
having said delivery to said user's interface device of multiple components including said research item locator component, said transaction component and said delivery component occur via electronic and/or communications channel or channels;
requiring said user to perform activity within said interface device to identify said small unit research information;
managing the delivery to said user's interface device of one or more results to said user activity to identify small unit research information;
requiring said user to perform activity to make selection from said results to said user activity to identify small unit research information;
permitting said user to make additions, alterations, or deletions to said selection from said results to said user activity to identify small unit research information;
permitting said user to purchase or otherwise acquire one or more of said selection from said results to said user activity to identify small unit research information via said transaction component;
managing the delivery of said purchase or otherwise acquire one or more of said selection from said results to said user activity to identify small unit research information via said delivery component;
allowing for each said user to be uniquely identified;
creating stored user activity event based on said activity performed by said uniquely identified said users; and
allowing said user to repeat the process.

2. The method of claim 1, wherein said electronics and/or communications channel or channels comprises information technology networks and sources including local area networks, Internet, Intranet, Extranets and local equipment; and communication networks and sources including digital and analog over-the-air transmissions, wireless transmissions, cable transmissions, and satellite transmissions.

3. The method of claim 1, wherein said interface device comprises all connected, interrelated or otherwise associated equipment or devices that allow said user to experience and/or interact with other available, authorized and/or otherwise accessible resources within said electronic and/or communications channel or channels.

4. The method of claim 1, wherein said research item information system resides within components containing an information technology processor and associated components that is accessed via said electronic and/or communications channel or channels.

5. The method of claim 1, wherein said a research item information system resides within components containing an information technology processor and associated components that is local to said user and not accessed via said electronic and/or communications channel or channels.

6. The method of claim 1, wherein said small unit research information comprises information of singular subject matter extracted or otherwise existing within a larger body of information but by itself is not sufficient to offer the necessary detail to fully understand the body of work from which it was drawn.

7. The method of claim 1, wherein said small unit research information comprises information available in a plurality of formats including text, graphics, video, interactive communication, animation, audio; over-the-air transmission such as television and radio; tactile materials, olfactory materials, and other information formats.

8. The method of claim 1, wherein said small unit research information comprises information located and accessible through said electronics and/or communications channel or channels.

9. The method of claim 1, wherein said small unit research information comprise:
materials used by one party in the process of educating, understanding, gaining knowledge, comprehending, and/or informing others;
materials supplied by another party including that developed by another party, that supplied but not developed by another party, and that referenced or linked by another party to other sources; and
materials that reside internally within components associated with said research item information system or reside externally to said research item information system and accessible via said electronic and/or communications channel or channels.

10. The method of claim 1, wherein one or more of components of said multiple components may exist separately or may exist concurrently within said user's interface device.

11. The method of claim 1, wherein said research item locator component allows said user to search or otherwise locate said small unit research information within components associated with said research item information system or components that are external to said research item information system.

12. The method of claim 1, wherein said component to allow purchase of said small unit research information provides access to elements necessary for processing a purchase transaction.

13. The method of claim 12, wherein said elements necessary for processing a purchase transaction includes elements that are internal or otherwise directly associated with said research item information system.

14. The method of claim 12, wherein said elements necessary for processing a purchase transaction includes elements that are external or otherwise not directly associated with said research item information system and are accessible via said electronic and/or communications channel or channels.

15. The method of claim 12, wherein said component to allow purchase of said small unit research information provides access to elements necessary for processing a purchase transaction includes elements to allow purchase transactions using micropayment transactions.

16. The method of claim 1, wherein said component to allow delivery of said small unit research information allows for electronic delivery and non-electronic delivery.

17. The method of claim 1, wherein said component to allow delivery of said small unit research information manages delivery of said small unit research information from it said electronics and/or communications channel or channels location.

18. The method of claim 1, wherein said delivery to said user's interface device of multiple components can occur with each components being delivered via the same said electronics and/or communications channel or channels or with different components being delivered via different said electronics and/or communications channel or channels.

19 The method of claim 1, wherein said user consists of a single individual or a group of individuals.

20. The method of claim 19, wherein said group of individuals may access said research item information system from more than one and different said interface devices connected to said electronics and/or communications channel or channels.

21. A research item information system, comprising:
research item locator system for locating, selecting and otherwise providing information related to small unit research information;
transaction system for handling purchase of selected said small unit research information;
user activity storage system for tracking and storing the activity of a user within said research item information system;
research item delivery system for providing means of delivery of purchased said small unit research information;
means for managing the delivery to a user's interface device and via electronic and/or communications channel or channels, of one or more components for locating, selecting, purchasing and receiving delivery of said small unit research information;
means for designating stored user activity event upon said user activity related to said small unit research information;
storage areas for retaining information related to small unit research information;
storage areas for retaining said stored user activity event;
means for allowing modification to said stored user activity event; and
means for associating with said user said activities performed by said user within said research item information system system.

22. The system of claim 21, wherein said electronic and/or communications channel or channels comprise information technology networks and sources including local area networks, Internet, Intranet, Extranets and local equipment; and communication networks and sources including digital and analog over-the-air transmissions, wireless transmissions, cable transmissions, and satellite transmissions.

23. The system in claim 21, wherein said research item information system resides within components containing an information technology processor and associated components.

24. The system in claim 21, wherein said components containing an information technology processor and associated components are accessed via said electronic and/or communications channel or channels.

25. The system in claim 21, wherein said components containing an information technology processor and associated components are local to said user and not accessed via said electronic and/or communications channel or channels.

26. The system of claim 21, wherein said small unit research information comprises:
information of singular subject matter extracted or otherwise existing within a larger body of information but by itself is not sufficient to offer the necessary detail to fully understand the body of work from which it was drawn; and
information available in a plurality of formats including text, graphics, video, interactive communication, animation, audio; over-the-air transmission such as television and radio; tactile materials, olfactory materials, and other information formats.

27. The system of claim 21, wherein said small unit research information comprises information located and accessible through said electronics and/or communications channel or channels.

28. The system of claim 21, wherein said small unit research information comprise:
materials used by one party in the process of educating, understanding, gaining knowledge, comprehending, and/or informing others;
materials supplied by another party including that developed by another party, that supplied but not developed by another party, and that referenced or linked by another party to other sources; and
materials that reside internally within components associated with said research item information system or reside externally to said research item information system and accessible via said electronic and/or communications channel or channels.

29. The system of claim 21, wherein said managing the delivery to a user's interface device and via electronic and/or communications channel or channels, of one or more components may allow said components to exist separately or may exist concurrently within said user's interface device.

30. The system of claim 21, wherein said interface device comprises all connected, interrelated or otherwise associated equipment or devices that allow said user to experience and/or interact with other available, authorized and/or otherwise accessible resources within said electronic and/or communication channel or channels.

31. The system in claim 21, wherein transaction system provides assess to elements necessary for said handling purchase of selected said small unit research information.

32. The system in claim 31, wherein said elements necessary for said handling purchase of selected said small unit research information includes elements that are internal for otherwise directly associated with said research information system.

33. The system of claim 31, wherein said elements necessary for said handling purchase includes elements that are external or otherwise not directly associated with said research item information system and are accessible via said electronic and/or communications channel or channels.

34. The system of claim 21, wherein said transaction system contains a small payment transaction mechanism for assisting in purchase of small unit research information.

35. The system of claim 34, wherein said transaction system contains a small payment transaction mechanism for assisting in purchase of small unit research information includes means for allowing micropayment transactions.

36. The system of claim 21, wherein said storage areas for retaining information related to small unit research information contains information, references or characteristics related to said small unit research information.

37. The system of claim 21, wherein said research item delivery system of purchased said small unit research information allows for electronic delivery via said electronic and/or communications channel or channels of said purchased small unit research information.

38. The system of claim 21, wherein said research item delivery system of purchased said small unit research information allows for non-electronic delivery of said purchased small unit research information.

39. The method of claim 21, wherein said user consists of a single individual or a group of individuals.

40. The method of claim 39, wherein said group of individuals may concurrently access said assessment delivery and management system from more than one and different said interface devices connected to said electronics and/or communications channel or channels.
